(19) United States
(12) Patent Application Publication
(10) Pub. No.: US 2007/0273707 A1
(43) Pub. Date: Nov. 29, 2007

(54) Method for showing various color temperatures on a digital display

(75) Inventors: Wen-Jui Liao, Lujhu Township (TW); Chia-Wei Hu, Lujhu Township (TW)

Correspondence Address: ROSENBERG, KLEIN & LEE, 3458 ELLICOTT CENTER DRIVE-SUITE 101, ELLICOTT CITY, MD, 21043, US

(73) Assignee: Lite-On Technology Corporation

(21) Appl. No.: 11/440,149

(22) Filed: May 25, 2006

(51) Int. Cl. G09G 5/02

(52) U.S. Cl. 345/589

(57) ABSTRACT

A method for showing various color temperatures on a digital display simultaneously, which is more convenient and reduces the time users spend tuning color temperatures according to the different color temperatures shown in a video frame.

### BACKGROUND OF THE INVENTION

1. Field of the Invention

The present invention relates to a digital display screen, and more particularly to a method for showing various color temperatures on a digital display screen.

2. Description of the Prior Art

In the current era, consumer electronic products desire larger and larger devices whose performance is better and better. For example, display devices have developed from black and white screens to color screens, and from traditional cathode display screens to digital display screens. Users can now watch color films on color video frames. The costs, energy consumption and the volume of display devices have decreased, while the performance of the display devices has continued to improve with every passing year.

However, the favorite color temperatures of users often differ because the environments users inhabit are different. In the past, in order to choose their favorite color temperature, users needed to spend a lot of time tuning the color temperatures of video signals. Because previous display devices only showed each video signal with a single color temperature, users must change the single color temperature back and forth on the display screen. This not only increases inconvenience but also wastes a lot of time.

### SUMMARY OF THE INVENTION

It is the object of the present invention to divide a video signal into a plurality of image sections and show these image sections on a video frame simultaneously to support the requirements of users.

It is another object of the present invention to display the plural image sections with a plurality of color temperatures on a digital display screen simultaneously.

It is another object of the present invention that users can choose their favorite color temperature quickly according to the image sections shown on a display screen for further decreasing the time users spend making a decision and increasing convenience.

In order to achieve the above objects, the present invention provides a method for showing various color temperatures on a digital display screen simultaneously. The method predeterminedly drives a video signal control unit to divide a video signal into a plurality of image sections and further tunes the color temperatures of the image sections to be different after receiving a control signal. Moreover, the image sections with different color temperatures are transmitted to a display device for further showing on a video frame simultaneously. The video frame is dynamic or static.

Furthermore, the image sections are the product of horizontal M pixel units and vertical N pixel line units. The video signal control unit predeterminedly tunes the color temperatures of the image sections to be different and belong to different color temperature units.

### BRIEF DESCRIPTION OF THE DRAWINGS

The above and further advantages of this invention may be better understood by referring to the following description, taken in conjunction with the accompanying drawings, in which:

FIG. 1 is a system block diagram that illustrates the best embodiment of the present invention;

FIG. 2 is a flowchart that illustrates the tuning of the color temperatures of a video signal of the present invention;

FIG. 3 is a diagram that illustrates a video frame of the first embodiment of the present invention;

FIG. 4 is a diagram that illustrates a video frame of the second embodiment of the present invention; and

FIG. 5 is a diagram that illustrates a video frame of the third embodiment of the present invention.

The drawings will be described further in connection with the following detailed description of the present invention.

### DETAILED DESCRIPTION OF THE PREFERRED EMBODIMENTS

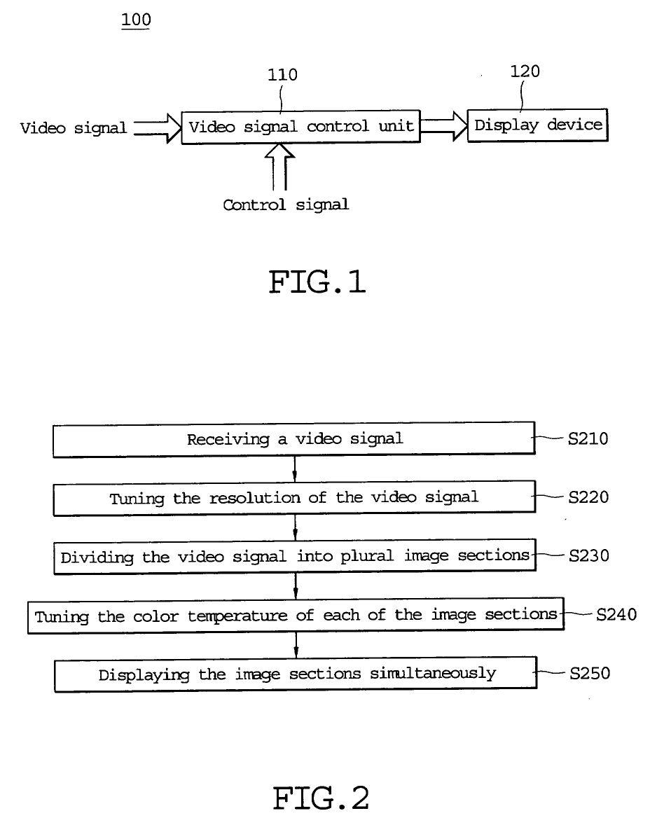

In FIG. 1, a block diagram that illustrates the best embodiment of the present invention is shown. The preferred embodiment is illustrated with a color temperature tuning system 100. The color temperature tuning system 100 includes a video signal control unit 110 and a display device 120.

The video signal control unit 110 includes a scalar chip and an on-screen display (OSD). The video signal control unit 110 is used to process a video signal and tunes the resolution or dots per inch (DPI), the color temperatures, and the positions of the vertical/horizontal pixels of the video signal. Moreover, the resolution of a video signal includes Vertical V pixel lines and Horizontal H pixels, i.e. the resolution is the product of V and H, and the video signal is a digital signal. The display device 120 shows the video signal processed by the video signal control unit 110 and can be an LCD screen, an LCD TV screen, or a plasma TV screen, etc.

In FIG. 2, a flowchart that illustrates the tuning of the color temperatures of a video signal is shown. The video signal control unit 110 receives a video signal, as Step 210. Then, the video signal control unit 110 scans a video signal for further tuning the resolution of the video signal based on a control signal that supports users' requirements. Here, the resolution of the video signal includes Vertical V pixel lines and Horizontal H pixels. Each of the pixel lines includes Horizontal H pixels, as Step 220.

Next, the video signal control unit 110 divides the video signal into plural image sections, i.e. the video signal will be divided into Horizontal M pixel units and Vertical N pixel line units. That is, the image sections are the product of horizontal M pixel units and vertical N pixel line units. Each of the image sections includes horizontal L pixels (H is the product of M and L) and vertical P pixel lines (V is the product of N and P). The resolution of each of the image sections is the product of L and P, as Step 230.

The video signal control unit 110 further tunes the color temperatures of each of the image sections respectively based on color matrix technology or offset-and-gain technology. For example, the color temperature of each of the image sections is different when it is being controlled by different color temperature units, such as a cool color temperature unit, a warm color temperature unit, a normal color temperature unit or another color temperature, as Step 240. Another color temperature can also be displayed in which the original settings or the previously selected color temperature for further being tuned to the latest selected color temperatures that users favor. In other words, when a user is determining a new color temperature to be displayed, they can compare the new setting to a previous setting.

Finally, the display device 120 shows the image sections of the video signal with different color temperatures simultaneously, as Step 250. Thus, users can make a decision from the image sections of the video signal with different color temperatures quickly. This will decrease the time that users spend choosing their favorite color temperature.

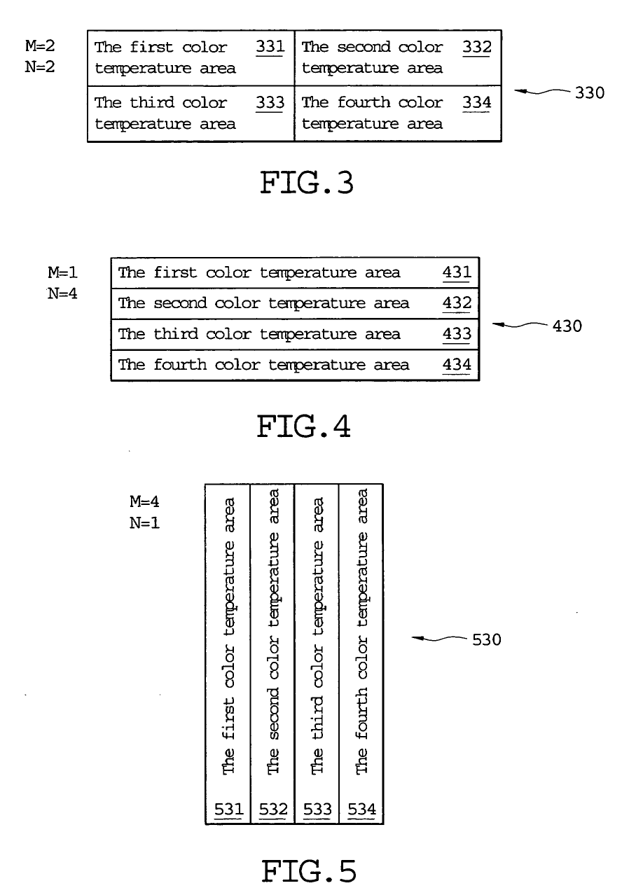

Please refer to FIG. 2 and FIG. 3. The first embodiment of the present invention is shown. First, as Step 210 and 220, the video signal control unit 110 predeterminedly tunes the resolution of the video signal, for example, to the product of 1024 and 768 (H=1024, V=768) in the color temperature tuning system 100 and predetermines M□ horizontal M pixel units □=2 and N□ vertical N pixel line units □=2. In other words, a video signal received by the color temperature tuning system 100 is divided into four image sections, and there are horizontal two pixel units and vertical two pixel line units on the video signal. Each of the image sections includes 512 horizontal pixels and 384 vertical pixel lines (L=512, P=384). Thus, the four image sections are respectively the first color temperature area 331, the second color temperature area 332, the third color temperature area 333, and the fourth color temperature area 334, as Step 230.

Next, the video signal control unit 110 respectively tunes the color temperatures of the four image sections after receiving a control signal. It should be noted that the video signal control unit 110 tunes the color temperature of each of the four image sections to be different as determined by different color temperature units based on the color matrix technique or the offset-and-gain technique. In the first embodiment of the present invention, the color temperature of the left part of the pixel units (the left part of the video frame 330), for example, is adjusted much higher than the right part of the pixel units (the right part of the video frame 330) thereof. The color temperature of the top of the pixel units (the top of the video frame 330), for example, is adjusted much higher than the bottom of the pixel units (the bottom of the video frame 330) thereof. That is, the color temperatures of the image sections shown on the video frame 330 are from higher to lower according to which the positions of the image sections are set from top to bottom and from left to right. As shown in FIG. 3, the first color temperature area 331 will become the standard color temperature as determined by the cool color temperature unit (e.g. 9300° K). The second color temperature area 332 will become the standard color temperature as determined by the normal color temperature unit (e.g. 6500° K). The third color temperature area 333 will become the standard color temperature as determined by the warm color temperature unit (e.g. 5500° K). The fourth color temperature area 334 will become another color temperature that displays the original settings, the previously selected color temperature or the latest selected color temperature that users favor, as Step 240. In this case, users can slightly tune the color temperature of the fourth color temperature area 334 to their favorites.

Finally, the video signal control unit 110 sends the four image sections with different color temperatures to the display device 120 for further displaying these image sections on a video frame 330 simultaneously. The video frame 330 is dynamic or static. Users can choose their favorite color temperature quickly according to the image sections shown simultaneously on a display screen, as Step 250.

The present invention further provides a second embodiment shown in FIG. 4. First, the video signal control unit 110 tunes the resolution of the video signal to the product of 1024 and 768 (H=1024, V=768) in the color temperature tuning system 100 and predetermines M=1 and N=4. In other words, the video signal received by the color temperature tuning system 100 is divided into four image sections, and there is one horizontal pixel unit and four vertical pixel line units on the video signal. Each of the image sections includes 1024 horizontal pixels and 192 vertical pixel lines (L=1024, P=192). Thus, the four image sections are respectively the first color temperature area 431, the second color temperature area 432, the third color temperature area 433, and the fourth color temperature area 434.

Then, the video signal control unit 110 respectively tunes the color temperatures of the four image sections after receiving a control signal. It should be noted that the video signal control unit 110 tunes the color temperature of each of the four image sections to be different as determined by different color temperature units based on the color matrix technique or the offset-and-gain technique. In the second embodiment of the present invention, the color temperatures of the top of the pixel line units (the top of the video frame 430) are adjusted much higher than the bottom of the pixel line units (the bottom of the video frame 430) thereof. That is, the color temperatures of the image sections shown on the video frame 430 are from higher to lower set from top to bottom of the image sections. As shown in FIG. 4, the first color temperature area 431 will become the standard color temperature in the cool color temperature unit. The second color temperature area 432 will become the standard color temperature in the normal color temperature unit. The third color temperature area 433 will become the standard color temperature in the warm color temperature unit. The fourth color temperature area 434 will become another color temperature can also be displayed in which the original settings, the previously selected color temperature or the latest selected color temperature that users favor, is shown. In this case, users can slightly tune the color temperature of the fourth color temperature area 334 to their favorites.

Finally, the video signal control unit 110 sends the four image sections to the display device 120 for further showing these image sections with different color temperatures. Users can make further decisions according to these image sections shown simultaneously on a video frame 430. The video frame 430 is dynamic or static

The present invention further provides a third embodiment shown in FIG. 5. First, the video signal control unit 110 tunes the resolution of the video signal to the product of 1024 and 768 (H=1024, V=768) in the color temperature tuning system 100 and predetermines M=4 and N=1. In other words, a video signal received by the color temperature tuning system 100 is divided into four image sections, and there are four horizontal pixel units and one vertical pixel line unit on the video signal. Each of the image sections includes 256 horizontal pixels and 768 vertical pixel lines (L=256, P=768). Thus, the four image sections are respectively the first color temperature area 531, the second color temperature area 532, the third color temperature area 533, and the fourth color temperature area 534.

Next, the video signal control unit 110 respectively tunes the color temperatures of the four image sections after receiving a control signal. It should be noted that the video signal control unit 110 tunes the color temperature of each of the four image sections to be different as determined by the different color temperature units based on the color matrix technique or the offset-and-gain technique. In the third embodiment of the present invention, the color temperature of the left part of the pixel units (the left part of the video frame 530) will become much higher, and the color temperature of the right part of the pixel units (the right part of the video frame 530) will become much lower. That is, the color temperatures of the image sections shown on the video frame 530 are from higher to lower set from left to right of the image sections. As shown in FIG. 5, the first color temperature area 531 will become the standard color temperature in the cool color temperature unit. The second color temperature area 532 will become the standard color temperature in the normal color temperature unit. The third color temperature area 533 will become the standard color temperature in the warm color temperature unit. The fourth color temperature area 534 will become another color temperature can also be displayed in which the original settings, the previously selected color temperature or the latest selected color temperature that users favor, is shown. In this case, users can slightly tune the color temperature of the fourth color temperature area 334 to their favorites.

Finally, the video signal control unit 110 sends the four image sections to the display device 120 for further showing these image sections with different color temperatures. Users can make further decisions according to these image sections shown simultaneously on a video frame 530. The video frame is dynamic or static.

An advantage of the present invention is that the video signal is divided into plural image sections and these image sections are shown on a video frame simultaneously to support users' requirements.

Another advantage of the present invention is that the plural image sections are shown with plural color temperatures on digital display screen simultaneously.

Yet another advantage of the present invention is that users can choose their favorite color temperature quickly according to the image sections shown on display screen thereby decreasing the time users spend making a decision and making the decision easy and more convenient.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A method for showing various color temperatures on a display device, comprising:
inputting a video signal to a video signal control unit;
dividing the video signal into plural image sections according to a control signal;
tuning plural color temperatures of the image sections; and
outputting the video signal to a display device for further showing the image sections with the plural color temperatures at the same time.

2. The method for showing various color temperatures according to claim 1, wherein the video signal includes a resolution that includes plural horizontal pixels and plural vertical pixel lines, i.e. each of the pixel lines include plural pixels.

3. The method for showing various color temperatures according to claim 2, wherein the video signal control unit divides the video signal into plural horizontal pixel units and plural vertical pixel line units, and the image sections are composed of the pixel units and the pixel line units.

4. The method for showing various color temperatures according to claim 2, wherein the video signal control unit horizontally divides the video signal into one horizontal pixel unit and plural vertical pixel units, and the image sections composed of the pixel unit and the pixel line units.

5. The method for showing various color temperatures according to claim 2, wherein the video signal control unit vertically divides the video signal into plural horizontal pixel units and one vertical pixel unit, and the image sections composed of the pixel units and the pixel line unit.

6. The method for showing various color temperatures according to claim 1, wherein the image sections are shown arranged on the display device based on the color temperatures of the image sections.

7. The method for showing various color temperatures according to claim 6, wherein the positions of the image sections shown on a video frame are set according to which the color temperatures of the image sections are set from high to low.

8. The method for showing various color temperatures according to claim 7, wherein the positions of the image sections shown on the video frame are set from a left side to a right side according to which the color temperatures of the image sections are set from high to low.

9. The method for showing various color temperatures according to claim 7, wherein the positions of the image sections shown on the video frame are set from top to bottom according to which the color temperatures of the image sections are set from high to low.

10. The method for showing various color temperatures according to claim 1, wherein the display device is a digital display screen.

11. The method for showing various color temperatures according to claim 10, wherein the digital display screen is an LCD, an LCD TV screen, or a plasma TV screen.

12. The method for showing various color temperatures according to claim 1, wherein the video signal is a digital signal.

13. The method for showing various color temperatures according to claim 1, wherein the video signal control unit includes a scalar chip.

14. The method for showing various color temperatures according to claim 1, wherein the video signal control unit includes an OSD.

15. The method for showing various color temperatures according to claim 1, wherein the color temperatures belong to different color temperature units.

16. The method for showing various color temperatures according to claim 1, wherein the color temperature units include a cool color temperature unit, a warm color temperature unit, and a normal color temperature unit.

17. The method for showing various color temperatures according to claim 16, wherein each of the color temperatures is a standard color temperature as determined by the color temperature units.

18. The method for showing various color temperatures according to claim 1, wherein the video signal control unit tunes the color temperatures of the image sections based on a color matrix technique or an offset-and-gain technique.

19. The method for showing various color temperatures according to claim 1, wherein the video signal control unit predeterminedly divides the video signal into the image sections.
